(19) United States
(12) Patent Application Publication
(10) Pub. No.: US 2023/0097940 A1
(43) Pub. Date: Mar. 30, 2023

(54) SYSTEM AND METHOD FOR EXTRACTING AND USING GROUPS OF FEATURES FOR INTERPRETABILITY ANALYSIS

(71) Applicants: David Sandai Kurokawa, Kirkland, WA (US); Shayak Sen, San Mateo, CA (US); Anupam Datta, Redwood City, CA (US); Divya Gopinath, Millwood, NY (US); Apoorv Gupta, Sunnyvale, CA (US)

(72) Inventors: David Sandai Kurokawa, Kirkland, WA (US); Shayak Sen, San Mateo, CA (US); Anupam Datta, Redwood City, CA (US); Divya Gopinath, Millwood, NY (US); Apoorv Gupta, Sunnyvale, CA (US)

(21) Appl. No.: 17/897,570

(22) Filed: Aug. 29, 2022

Related U.S. Application Data
(60) Provisional application No. 63/248,648, filed on Sep. 27, 2021.

(51) Int. Cl. G06N 20/00

(52) U.S. Cl. CPC G06N 20/00

(57) ABSTRACT

In some implementations, a computing machine accesses an artificial intelligence model and a dataset for the artificial intelligence model, the dataset comprising at least one datapoint. The computing machine identifies a feature group used by the artificial intelligence model, the feature group comprising at least two features having a similarity with one another exceeding a similarity threshold, wherein the feature group comprises a subset of the features used by the artificial intelligence model. The computing machine determines an overall influence value for the feature group on an output of the artificial intelligence model applied to the dataset. The computing machine provides an output representing the overall influence value.

This application claims the benefit of priority under 35 U.S.C. 119(e) to U.S. Provisional Patent Application Ser. No. 63/248,648, filed Sep. 27, 2021, which is incorporated herein by reference in its entirety.

### TECHNICAL FIELD

Embodiments pertain to computer architecture. Some embodiments relate to machine learning. Some embodiments relate to systems and methods for extracting and using groups of features for interpretability analysis.

### BACKGROUND

Machine learning models are used to solve many different problems from determining, by a bank, whether to make a loan to a customer based on information provided by the customer to the bank, to an autonomous vehicle making driving decisions based on visual, audio, and radar data. In some cases, interpretability of machine learning models may be desirable. For example, when a bank rejects a customer for a loan, the bank may specify the reasons for the rejection to ensure compliance with the law and best practices. Techniques for interpretability analysis of machine learning models may be desirable.

### BRIEF DESCRIPTION OF THE DRAWINGS

FIG. 1 illustrates the training and use of a machine-learning program, in accordance with some embodiments.

FIG. 2 illustrates an example neural network, in accordance with some embodiments.

FIG. 3 illustrates the training of an image recognition machine learning program, in accordance with some embodiments.

FIG. 4 illustrates the feature-extraction process and classifier training, in accordance with some embodiments.

FIG. 5 is a block diagram of a computing machine, in accordance with some embodiments.

FIG. 6 is a flowchart of an example process associated with extracting and using groups of features for interpretability analysis, in accordance with some embodiments.

FIG. 7 illustrates an example graph visualization, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Aspects of the present technology may be implemented as part of a computer system. The computer system may be one physical machine, or may be distributed among multiple physical machines, such as by role or function, or by process thread in the case of a cloud computing distributed model. In various embodiments, aspects of the technology may be configured to run in virtual machines that in turn are executed on one or more physical machines. It will be understood by persons of skill in the art that features of the technology may be realized by a variety of different suitable machine implementations.

The system includes various engines, each of which is constructed, programmed, configured, or otherwise adapted, to carry out a function or set of functions. The term engine as used herein means a tangible device, component, or arrangement of components implemented using hardware, such as by an application specific integrated circuit (ASIC) or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium. Software residing in non-executable form may be compiled, translated, or otherwise converted to an executable form prior to, or during, runtime. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

Considering examples in which engines are temporarily configured, each of the engines may be instantiated at different moments in time. For example, where the engines comprise a general-purpose hardware processor core configured using software, the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any particular implementation exemplified herein, unless such limitations are expressly called out.

In addition, an engine may itself be composed of more than one sub-engines, each of which may be regarded as an engine in its own right. Moreover, in the embodiments described herein, each of the various engines corresponds to a defined functionality; however, it should be understood that in other contemplated embodiments, each functionality may be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

As used herein, the term “model” encompasses its plain and ordinary meaning. A model may include, among other things, one or more engines which receive an input and compute an output based on the input. The output may be a classification. For example, an image file may be classified as depicting a cat or not depicting a cat. Alternatively, the image file may be assigned a numeric score indicating a likelihood whether the image file depicts the cat, and image files with a score exceeding a threshold (e.g., 0.9 or 0.95) may be determined to depict the cat.

This document may reference a specific number of things (e.g., “six mobile devices”). Unless explicitly set forth otherwise, the numbers provided are examples only and may be replaced with any positive integer, integer or real number, as would make sense for a given situation. For example, “six mobile devices” may, in alternative embodiments, include any positive integer number of mobile devices. Unless otherwise mentioned, an object referred to in singular form (e.g., “a computer” or “the computer”) may include one or multiple objects (e.g., “the computer” may refer to one or multiple computers).

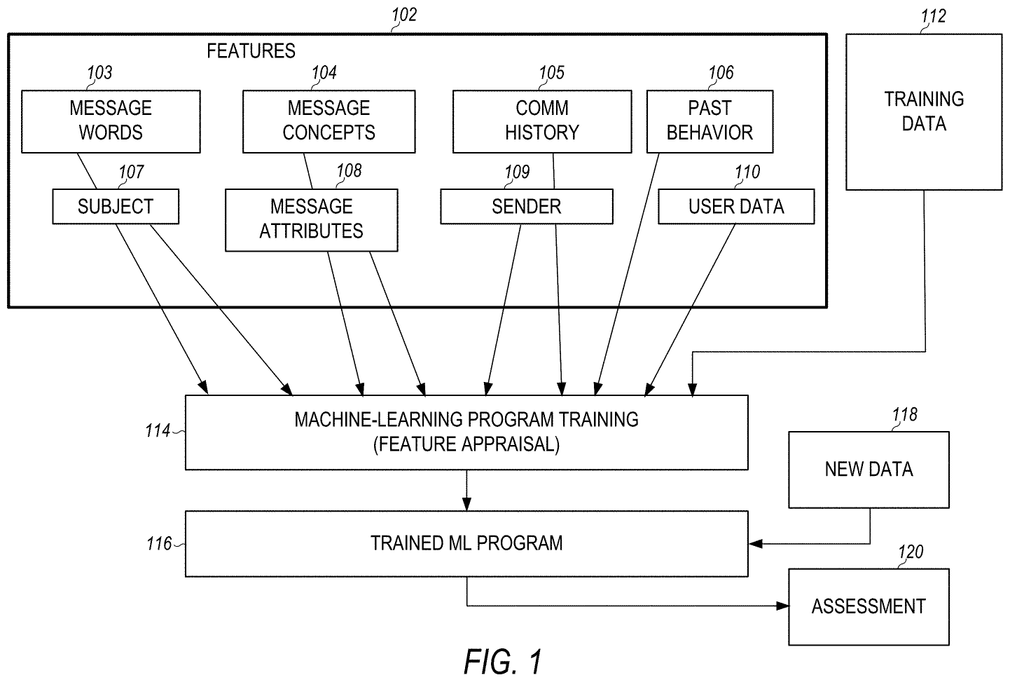

FIG. 1 illustrates the training and use of a machine-learning program, according to some example embodiments. In some example embodiments, machine-learning programs (MLPs), also referred to as machine-learning algorithms or tools, are utilized to perform operations associated with machine learning tasks, such as image recognition or machine translation.

Machine learning is a field of study that gives computers the ability to learn without being explicitly programmed. Machine learning explores the study and construction of algorithms, also referred to herein as tools, which may learn from existing data and make predictions about new data. Such machine-learning tools operate by building a model from example training data 112 in order to make data-driven predictions or decisions expressed as outputs or assessments 120. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange). Regression algorithms aim at quantifying some items (for example, by providing a value that is a real number). The machine-learning algorithms utilize the training data 112 to find correlations among identified features 102 that affect the outcome.

The machine-learning algorithms utilize features 102 for analyzing the data to generate assessments 120. A feature 102 is an individual measurable property of a phenomenon being observed. The concept of a feature is related to that of an explanatory variable used in statistical techniques such as linear regression. Choosing informative, discriminating, and independent features is important for effective operation of the MLP in pattern recognition, classification, and regression. Features may be of different types, such as numeric features, strings, and graphs.

In one example embodiment, the features 102 may be of different types and may include one or more of words of the message 103, message concepts 104, communication history 105, past user behavior 106, subject of the message 107, other message attributes 108, sender 109, and user data 110.

The machine-learning algorithms utilize the training data 112 to find correlations among the identified features 102 that affect the outcome or assessment 120. In some example embodiments, the training data 112 includes labeled data, which is known data for one or more identified features 102 and one or more outcomes, such as detecting communication patterns, detecting the meaning of the message, generating a summary of the message, detecting action items in the message, detecting urgency in the message, detecting a relationship of the user to the sender, calculating score attributes, calculating message scores, etc.

With the training data 112 and the identified features 102, the machine-learning tool is trained at operation 114. The machine-learning tool appraises the value of the features 102 as they correlate to the training data 112. The result of the training is the trained machine-learning program 116.

When the machine-learning program 116 is used to perform an assessment, new data 118 is provided as an input to the trained machine-learning program 116, and the machine-learning program 116 generates the assessment 120 as output. For example, when a message is checked for an action item, the machine-learning program utilizes the message content and message metadata to determine if there is a request for an action in the message.

Machine learning techniques train models to accurately make predictions on data fed into the models (e.g., what was said by a user in a given utterance; whether a noun is a person, place, or thing; what the weather will be like tomorrow). During a learning phase, the models are developed against a training dataset of inputs to optimize the models to correctly predict the output for a given input. Generally, the learning phase may be supervised, semi-supervised, or unsupervised; indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs (e.g., iterations), in which the training dataset is repeatedly fed into the model to refine its results. For example, in a supervised learning phase, a model is developed to predict the output for a given set of inputs, and is evaluated over several epochs to more reliably provide the output that is specified as corresponding to the given input for the greatest number of inputs for the training dataset. In another example, for an unsupervised learning phase, a model is developed to cluster the dataset into n groups, and is evaluated over several epochs as to how consistently it places a given input into a given group and how reliably it produces the n desired clusters across each epoch.

Once an epoch is run, the models are evaluated and the values of their variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the machine learning technique used. For example, in a genetic or evolutionary algorithm, the values for the models that are most successful in predicting the desired outputs are used to develop values for models to use during the subsequent epoch, which may include random variation/mutation to provide additional data points. One of ordinary skill in the art will be familiar with several other machine learning algorithms that may be applied with the present disclosure, including linear regression, random forests, decision tree learning, neural networks, deep neural networks, etc.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the n^{th} epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusterings is used to select a model that produces the clearest bounds for its clusters of data.

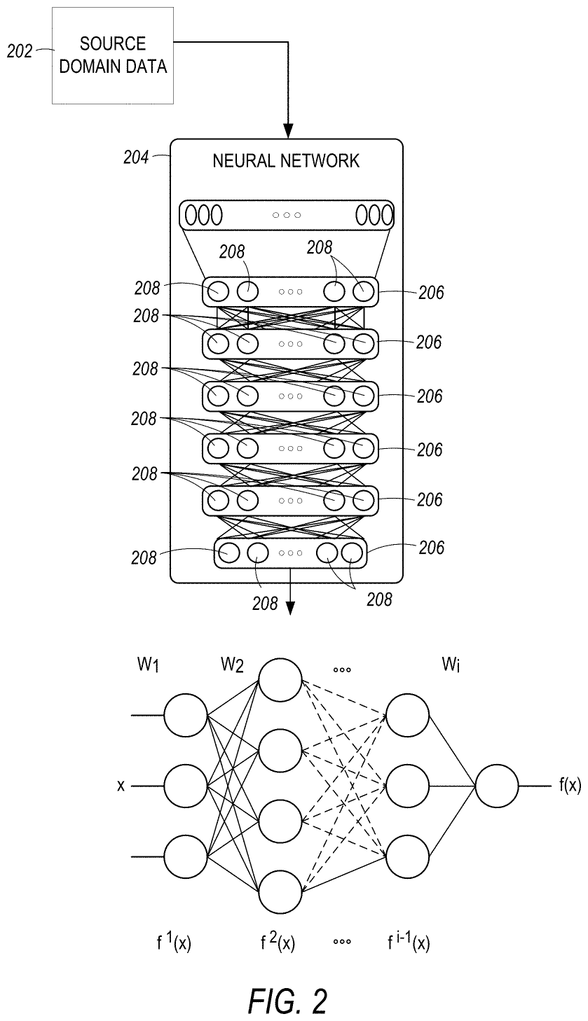

FIG. 2 illustrates an example neural network 204, in accordance with some embodiments. As shown, the neural network 204 receives, as input, source domain data 202. The input is passed through a plurality of layers 206 to arrive at an output. Each layer 206 includes multiple neurons 208. The neurons 208 receive input from neurons of a previous layer and apply weights to the values received from those neurons in order to generate a neuron output. The neuron outputs from the final layer 206 are combined to generate the output of the neural network 204.

As illustrated at the bottom of FIG. 2, the input is a vector x. The input is passed through multiple layers 206, where weights W₁, W₂, . . . , Wᵢ are applied to the input to each layer to arrive at f¹(x), f²(x), . . . , fⁱ⁻¹(x), until finally the output f(x) is computed.

In some example embodiments, the neural network 204 (e.g., deep learning, deep convolutional, or recurrent neural network) comprises a series of neurons 208, such as Long Short Term Memory (LSTM) nodes, arranged into a network. A neuron 208 is an architectural element used in data processing and artificial intelligence, particularly machine learning, which includes memory that may determine when to “remember” and when to “forget” values held in that memory based on the weights of inputs provided to the given neuron 208. Each of the neurons 208 used herein are configured to accept a predefined number of inputs from other neurons 208 in the neural network 204 to provide relational and sub-relational outputs for the content of the frames being analyzed. Individual neurons 208 may be chained together and/or organized into tree structures in various configurations of neural networks to provide interactions and relationship learning modeling for how each of the frames in an utterance are related to one another.

For example, an LSTM node serving as a neuron includes several gates to handle input vectors (e.g., phonemes from an utterance), a memory cell, and an output vector (e.g., contextual representation). The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation. One skilled in the art will appreciate that neurons and neural networks may be constructed programmatically (e.g., via software instructions) or via specialized hardware linking each neuron to form the neural network.

Neural networks utilize features for analyzing the data to generate assessments (e.g., recognize units of speech). A feature is an individual measurable property of a phenomenon being observed. The concept of feature is related to that of an explanatory variable used in statistical techniques such as linear regression. Further, deep features represent the output of nodes in hidden layers of the deep neural network.

A neural network, sometimes referred to as an artificial neural network, is a computing system/apparatus based on consideration of biological neural networks of animal brains. Such systems/apparatus progressively improve performance, which is referred to as learning, to perform tasks, typically without task-specific programming. For example, in image recognition, a neural network may be taught to identify images that contain an object by analyzing example images that have been tagged with a name for the object and, having learnt the object and name, may use the analytic results to identify the object in untagged images. A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

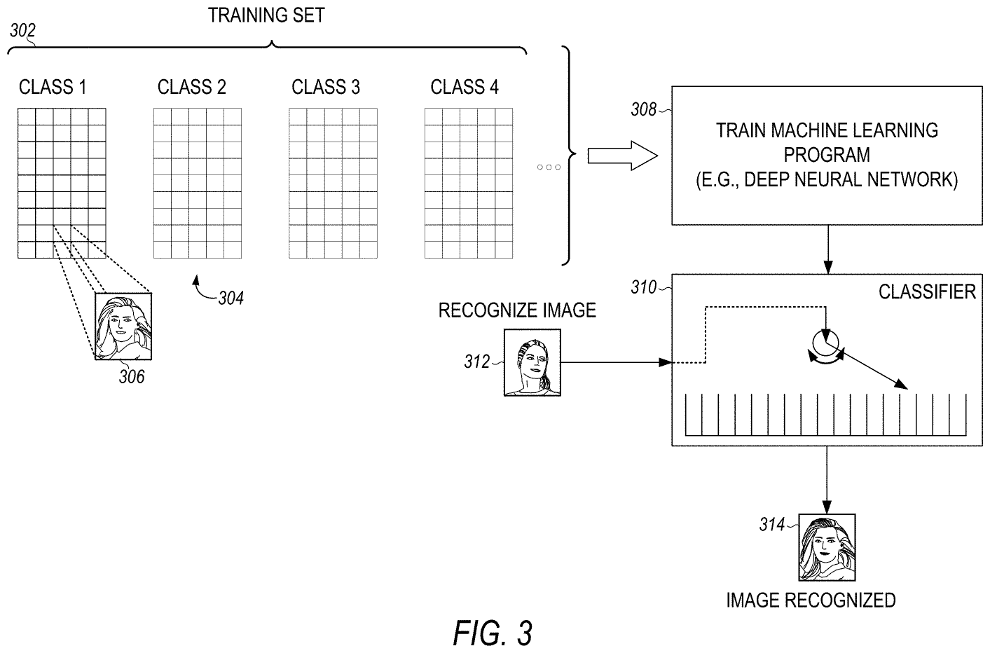

FIG. 3 illustrates the training of an image recognition machine learning program, in accordance with some embodiments. The machine learning program may be implemented at one or more computing machines. A training set 302 includes multiple classes 304. Each class 304 includes multiple images 306 associated with the class. Each class 304 may correspond to a type of object in the image 306 (e.g., a digit 0-9, a man or a woman, a cat or a dog, etc.). In one example, the machine learning program is trained to recognize images of the presidents of the United States, and each class corresponds to each president (e.g., one class corresponds to Barack Obama, one class corresponds to George W. Bush, one class corresponds to Bill Clinton, etc.). At block 308 the machine learning program is trained, for example, using a deep neural network. A trained classifier 310, generated by the training of block 308, recognizes an image 312 as image 314. For example, if the image 312 is a photograph of Bill Clinton, the classifier recognizes the image as corresponding to Bill Clinton at image 314.

FIG. 3 illustrates the training of a classifier, according to some example embodiments. A machine learning algorithm is designed for recognizing faces, and a training set 302 includes data that maps a sample to a class 304 (e.g., a class includes all the images of purses). The classes may also be referred to as labels. Although embodiments presented herein are presented with reference to object recognition, the same principles may be applied to train machine-learning programs used for recognizing any type of items.

The training set 302 includes a plurality of images 306 for each class 304 (e.g., image 306), and each image is associated with one of the categories to be recognized (e.g., a class). The machine learning program is trained 308 with the training data to generate a classifier 310 operable to recognize images. In some example embodiments, the machine learning program is a DNN.

When an input image 312 is to be recognized, the classifier 310 analyzes the input image 312 to identify the class (e.g., class of image 314) corresponding to the input image 312.

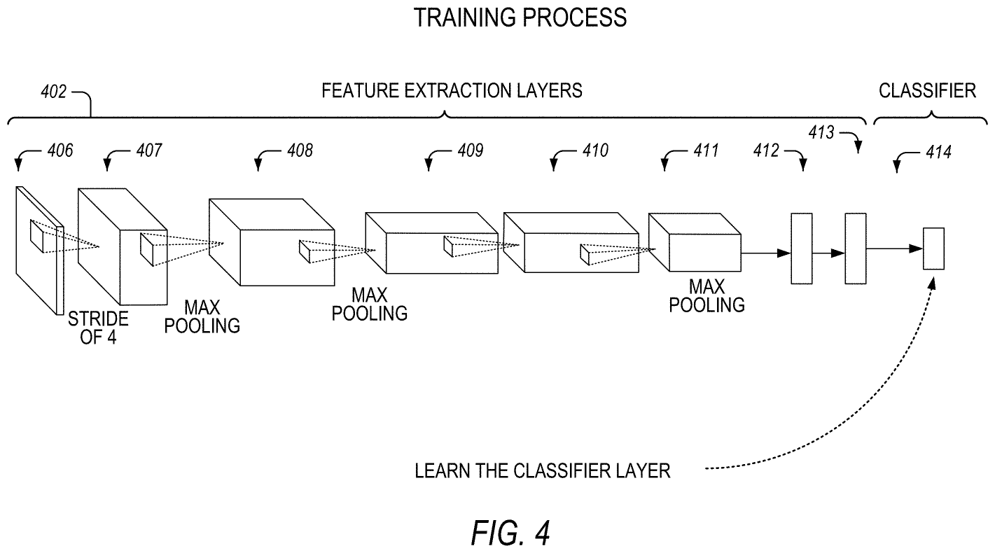

FIG. 4 illustrates the feature-extraction process and classifier training, according to some example embodiments. Training the classifier may be divided into feature extraction layers 402 and classifier layer 414. Each image is analyzed in sequence by a plurality of layers 406-413 in the feature-extraction layers 402.

With the development of deep convolutional neural networks, the focus in face recognition has been to learn a good face feature space, in which faces of the same person are close to each other, and faces of different persons are far away from each other. For example, the verification task with the LFW (Labeled Faces in the Wild) dataset has been often used for face verification.

Many face identification tasks (e.g., MegaFace and LFW) are based on a similarity comparison between the images in the gallery set and the query set, which is essentially a K-nearest-neighborhood (KNN) method to estimate the person's identity. In the ideal case, there is a good face feature extractor (inter-class distance is always larger than the intra-class distance), and the KNN method is adequate to estimate the person's identity.

Feature extraction is a process to reduce the amount of resources required to describe a large set of data. When performing analysis of complex data, one of the major problems stems from the number of variables involved. Analysis with a large number of variables generally requires a large amount of memory and computational power, and it may cause a classification algorithm to overfit to training samples and generalize poorly to new samples. Feature extraction is a general term describing methods of constructing combinations of variables to get around these large data-set problems while still describing the data with sufficient accuracy for the desired purpose.

In some example embodiments, feature extraction starts from an initial set of measured data and builds derived values (features) intended to be informative and non-redundant, facilitating the subsequent learning and generalization steps. Further, feature extraction is related to dimensionality reduction, such as reducing large vectors (sometimes with very sparse data) to smaller vectors capturing the same, or similar, amount of information.

Determining a subset of the initial features is called feature selection. The selected features are expected to contain the relevant information from the input data, so that the desired task can be performed by using this reduced representation instead of the complete initial data. DNN utilizes a stack of layers, where each layer performs a function. For example, the layer could be a convolution, a non-linear transform, the calculation of an average, etc. Eventually this DNN produces outputs by classifier layer 414. In FIG. 4, the data travels from left to right and the features are extracted. The goal of training the neural network is to find the parameters of all the layers that make them adequate for the desired task.

As shown in FIG. 4, a “stride of 4” filter is applied at layer 406, and max pooling is applied at layers 407-413. The stride controls how the filter convolves around the input volume. “Stride of 4” refers to the filter convolving around the input volume four units at a time. Max pooling refers to down-sampling by selecting the maximum value in each max pooled region.

In some example embodiments, the structure of each layer is predefined. For example, a convolution layer may contain small convolution kernels and their respective convolution parameters, and a summation layer may calculate the sum, or the weighted sum, of two pixels of the input image. Training assists in defining the weight coefficients for the summation.

One way to improve the performance of DNNs is to identify newer structures for the feature-extraction layers, and another way is by improving the way the parameters are identified at the different layers for accomplishing a desired task. The challenge is that for a typical neural network, there may be millions of parameters to be optimized. Trying to optimize all these parameters from scratch may take hours, days, or even weeks, depending on the amount of computing resources available and the amount of data in the training set.

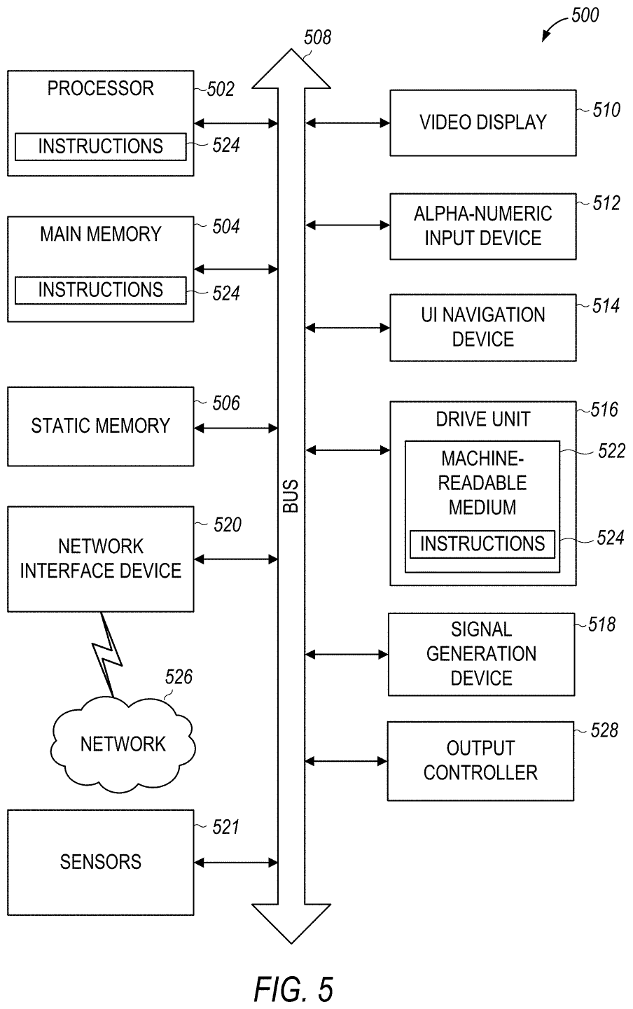

FIG. 5 illustrates a circuit block diagram of a computing machine 500 in accordance with some embodiments. In some embodiments, components of the computing machine 500 may store or be integrated into other components shown in the circuit block diagram of FIG. 5. For example, portions of the computing machine 500 may reside in the processor 502 and may be referred to as “processing circuitry.” Processing circuitry may include processing hardware, for example, one or more central processing units (CPUs), one or more graphics processing units (GPUs), and the like. In alternative embodiments, the computing machine 500 may operate as a standalone device or may be connected (e.g., networked) to other computers. In a networked deployment, the computing machine 500 may operate in the capacity of a server, a client, or both in server-client network environments. In an example, the computing machine 500 may act as a peer machine in peer-to-peer (P2P) (or other distributed) network environment. In this document, the phrases P2P, device-to-device (D2D) and sidelink may be used interchangeably. The computing machine 500 may be a specialized computer, a personal computer (PC), a tablet PC, a personal digital assistant (PDA), a mobile telephone, a smart phone, a web appliance, a network router, switch or bridge, or any machine capable of executing instructions (sequential or otherwise) that specify actions to be taken by that machine.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems/apparatus (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The computing machine 500 may include a hardware processor 502 (e.g., a central processing unit (CPU), a GPU, a hardware processor core, or any combination thereof), a main memory 504 and a static memory 506, some or all of which may communicate with each other via an interlink (e.g., bus) 508. Although not shown, the main memory 504 may contain any or all of removable storage and non-removable storage, volatile memory or non-volatile memory. The computing machine 500 may further include a video display unit 510 (or other display unit), an alphanumeric input device 512 (e.g., a keyboard), and a user interface (UI) navigation device 514 (e.g., a mouse). In an example, the display unit 510, input device 512 and UI navigation device 514 may be a touch screen display. The computing machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The computing machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The drive unit 516 (e.g., a storage device) may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the computing machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the computing machine 500 and that cause the computing machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526.

As discussed above, artificial intelligence and/or machine learning models are used to solve many different problems from determining whether to make a loan to a customer based on information about the customer known to a bank, to an autonomous vehicle making driving decisions based on, among other things, visual, audio, and radar data. In some cases, interpretability of artificial intelligence models may be desirable. For example, when a bank rejects a customer for a loan, the bank may specify the reasons for the rejection to ensure compliance with the law and best practices. Techniques for interpretability analysis of artificial intelligence models may be desirable.

Embodiments of the technology disclosed herein provide, among other things, techniques for interpretability analysis of artificial intelligence models. In some implementations, a computing machine accesses an artificial intelligence model and a nonempty dataset for the artificial intelligence model. The dataset includes at least one datapoint. The computing machine identifies a feature group used by the artificial intelligence model, the feature group comprising at least two features having a similarity with one another exceeding a similarity threshold, wherein the feature group comprises a subset of the features used by the artificial intelligence model. The computing machine determines an overall influence value for the feature group on an output of the artificial intelligence model applied to the dataset. The computing machine provides an output representing the overall influence value.

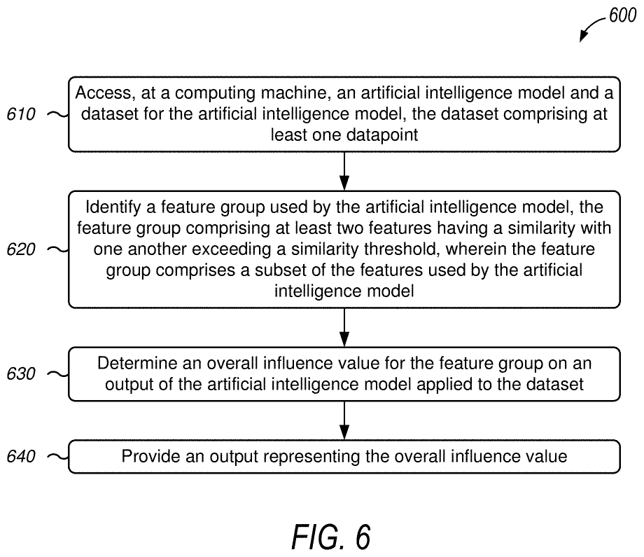

FIG. 6 is a flowchart of an example process 600 associated with extracting and using groups of features for interpretability analysis. In some implementations, one or more process blocks of FIG. 6 may be performed by a computing machine (e.g., computing machine 500). In some implementations, one or more process blocks of FIG. 6 may be performed by another device or a group of devices separate from or including the computing machine. Additionally, or alternatively, one or more process blocks of FIG. 6 may be performed by one or more components of the computing machine 500, such as processor 502, main memory 504, static memory 506, network interface device 520, video display 510, alpha-numeric input device 512, UI navigation device 514, drive unit 516, signal generation device 518, and/or output controller 528.

As shown in FIG. 6, process 600 may include accessing, at a computing machine, an artificial intelligence model and a dataset for the artificial intelligence model, the dataset comprising at least one datapoint (block 610). For example, the computing machine may access an artificial intelligence model and a dataset for the artificial intelligence model, the dataset comprising at least one datapoint, as described above.

As further shown in FIG. 6, process 600 may include identifying a feature group used by the artificial intelligence model, the feature group comprising at least two features having a similarity with one another exceeding a similarity threshold, wherein the feature group comprises a subset of the features used by the artificial intelligence model (block 620). For example, the computing machine may identify a feature group used by the artificial intelligence model, the feature group comprising at least two features having a similarity with one another exceeding a similarity threshold, wherein the feature group comprises a subset of the features used by the artificial intelligence model, as described above.

As further shown in FIG. 6, process 600 may include determining an overall influence value for the feature group on an output of the artificial intelligence model applied to the dataset (block 630). For example, the computing machine may determine an overall influence value for the feature group on an output of the artificial intelligence model applied to the dataset, as described above.

As further shown in FIG. 6, process 600 may include providing an output representing the overall influence value (block 640). For example, the computing machine may provide an output representing the overall influence value, as described above.

Process 600 may include additional implementations, such as any single implementation or any combination of implementations described below and/or in connection with one or more other processes described elsewhere herein.

In a first implementation, the identified features group is manually identified by a user of the computing machine.

In a second implementation, the identified features group is identified semi-automatically or fully-automatically.

In a third implementation, the feature group is identified, at the computing machine, using an undirected weighted graph data structure.

In a fourth implementation, the graph data structure comprises vertices representing features and edge weights representing similarities between features. Edge weights may be computed using any feature similarity technique. Edge weights may be computed using any distribution similarity metric by interpreting empirical datasets as distributions.

In a fifth implementation, the similarities between the features correspond to an absolute value of a correlation between the features.

In a sixth implementation, the similarities between the features correspond to a measure of the mutual information between the features or an information gain from a first feature from among the features to a second feature from among the features.

In a seventh implementation, the similarities between the features correspond to a symmetrized version of the mutual information.

In an eighth implementation, the symmetrized version of the mutual information comprises a symmetric uncertainty.

In a ninth implementation, the similarities between the features correspond to a feature similarity metric.

In a tenth implementation, the similarity between the features corresponds to a statistical correlation metric.

In an eleventh implementation, the similarity between the features corresponds to an information theoretic dependence metric.

In a twelfth implementation, determining the overall influence value for the feature group on the output of the artificial intelligence model applied to the dataset comprises determining a Shapley value of each and every feature in the feature group, and summing the determined Shapley values to compute the overall influence value.

In a thirteenth implementation, determining the overall influence value for the feature group on the output of the artificial intelligence model applied to the dataset comprises computing a Shapley value of the feature group as the overall influence value.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

Some embodiments present a system and method for extracting and using groups of features for interpretability analysis. Given a source model (e.g., an artificial intelligence model) and dataset for which the model may provide a prediction, the system and method enables the ability to extract natural groups of features and utilize them to interpret the model. Some embodiments are related to the general problems of model interpretability and feature engineering.

As used herein, the phrase, “model interpretability” may include, among other things, the process of understanding a machine learning model's decisions/predictions. This can be used for several reasons such as the following: (1) complying with regulation (such as encoded by a country's laws or a company's rules, e.g., in some jurisdictions, laws are in place to ensure loan making decisions are not based on protected class status), (2) improving a model (understanding the decisions a model makes can lead to a betterment of the training and data gathering process), and (3) helping human overseers understand a model in general.

Feature engineering may include, among other things, the process of applying functions and transforms on raw data to improve model (e.g., an artificial intelligence model) performance. One important aspect of this is identifying and understanding related and/or correlated features. This is especially important in situations where a machine learning (ML) practitioner wishes to create a model that allows for complex non-linear relationships between features while simultaneously coming from a simple model class (such as linear models). In such situations often features are generated that are the output of some function between two or more features. For example, the two raw features of height and weight in a life insurance underwriting model may be used to compute a body mass index (BMI) feature, where BMI is a mathematical function of height and weight.

Some embodiments are based on the steps below, addressing the model interpretability and feature engineering problems for a group of features and the optional generation of such interesting groups.

One example embodiment is summarized as “Method 1” below. Some implementations may include only a portion of the features of “Method 1” summarized below.

### Method 1:

1. Input:
a. A model.
b. A dataset comprising at least one datapoint.
c. In some embodiments, a group of features used by the model. This may, in some cases, include more than one feature and less than all of them.

2. System and Method:
a. If no feature group is provided, generate one either semi-automatically (method 1.1.a) or fully-automatically (method 1.1.b) via the use of comparing the similarities of features.
b. Determine the overall influence of the provided group of features by the model on the each of the provided datapoints via, for example, one of the following:
   i. Summing the individual Shapley values of each feature in the group (Method 1.2.a).
   ii. Computing the Shapley value of the group of features as a single entity (Method 1.2.b).
c. More uses of groups:
   i. Identify important feature groups.
   ii. Identify causes of bias in terms of groups.
   iii. Identify causes of stability/instability in terms of groups.
d. Allow for any analysis pertaining to a single feature (such as computing the mean absolute value of the Shapley values for all provided data points as an aggregate statistic of importance) to pertain to the group of features. The exact operations to be performed here may depend on the exact analysis.
e. And other applications.

According to Method 1.1, described above, to generate interesting feature groups, some embodiments first construct a graph where the vertices represent the features and the edges represent similarities between the features. These similarities can be computed in a variety of ways, for example (but not limited to): (1) computing the absolute value of the correlation, (2) computing the mutual information (e.g., the information gain), (3) computing some symmetrized version of the mutual information, for example, the symmetric uncertainty.

In metrics requiring distributional information (e.g., (2) and (3) above), some embodiments estimate this via density estimation approaches (e.g., kernel density estimation (KDE)), via the sample distribution directly, or via bucketizing. Some implementations may approximate these metrics as the cost (in terms of time or computational resources) to compute them exactly may be high. These computations can be done by taking the raw feature values or by first projecting into the influence space. For example, by first transforming each feature value into its Shapley/influence value and then computing the desired metric.

In some cases, this may amount to constructing a square matrix of size n such that the entry in the i^{th} row and j^{th} column corresponds to the chosen metric between the i^{th} and j^{th} features. This can be stored in a two-dimensional (2D) array-like structure (e.g., a numpy ndarray). If the number of features is large and computing all the entries in the matrix are prohibitively expensive, some embodiments may first approximate which values may be relatively high and then computing the metrics only for these pairs of features.

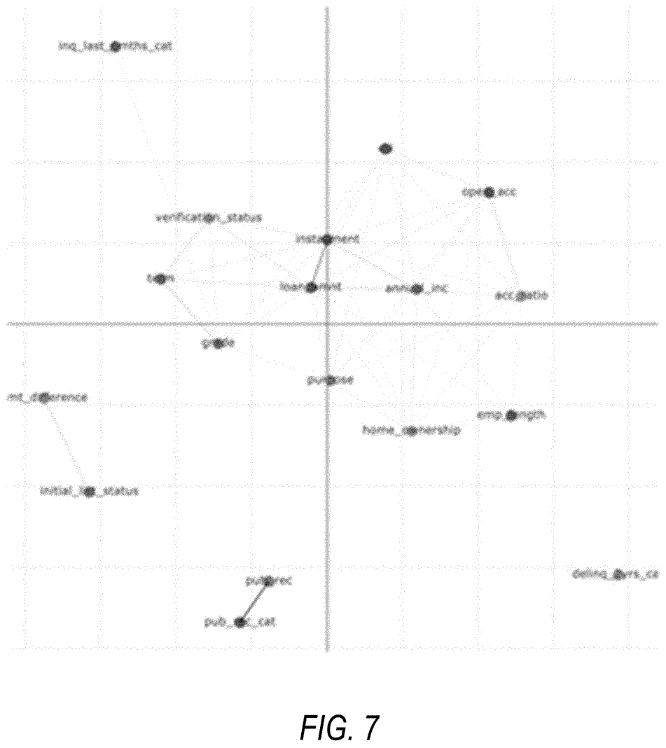

According to Method 1.1.a, once the graph shown in FIG. 7 (or a similar graph for other data) is generated, in some embodiments the computing machine can visualize the graph via a force-directed graph visualization, as illustrated in FIG. 7. If generating feature groups manually, a user can take the visualization shown in FIG. 7 to generate helpful segments. Alternatively, this may be done automatically by the computing machine. For example, in FIG. 7, the user or the computing machine may determine that a good feature grouping is the pub_rec and pub_rec_cat feature. This determination may be made based on the proximity in the graph of the datapoints or based on the similarity of the feature names.

According to Method 1.1.b, a more fully-automated approach is to generate highly connected components of the graph via standard graph theory tools such as in spectral analysis. These components would then correspond to the feature groups of interest.

According to Method 1.2, to determine the overall influence of a feature group some embodiments may use one or both of the following two possible approaches: (1) summing the individual values of an influence metric (for example Shapley values of each feature in the group as in Equation 1, Method 1.2.a), or (2) computing the influence of a group of features in a group influence metric (like a group Shapley value of the group of features in Equation 2, Method 1.2.b). Other individual and group influence metrics, such as but not exclusively Unary QII/Set QII may also be used.

As used herein, the Shapley value is a solution concept in cooperative game theory. To each cooperative game it assigns a unique distribution (among the players) of a total surplus generated by the coalition of all players. The Shapley value is characterized by a collection of desirable properties. The setup is as follows: a coalition of players cooperates, and obtains a certain overall gain from that cooperation. Since some players may contribute more to the coalition than others or may possess different bargaining power (for example threatening to destroy the whole surplus), what final distribution of generated surplus among the players should arise in any particular game? Or phrased differently: how important is each player to the overall cooperation, and what payoff can he or she reasonably expect? The Shapley value provides one possible answer to this question.

Formally, a coalition game is defined as, there is a set N (of n players) and a function v that maps the subset of players to the real numbers, with v(0) being the empty set. The function v has the following meaning: if S is a coalition of players, then v(S), called the worth of the coalition S, described the total expected sum of payoffs the members of S can obtain by cooperation.

The Shapley value is one way to distribute the total gains to the players. According to the Shapley value, the amount that player i gets in a coalition game (v, N) is defined in Equation 1.

$${φ}_{i} ( v ) = {\sum }_{S ⊆ N \backslash \{ i \}} \frac{\vert S \vert ! ( n - \vert S \vert - 1 ) !}{n !} ( v ( S ⋃ \{ i \} ) - v ( S ) ) \qquad Equation 1$$

In Equation 1, n is the total number of players and the sum extends over all subsets S of N not containing player i.

Quantitative Input Influence (QII), computes feature influences for a data point x for some ML model v in the context of a background dataset Z. In this scenario, the players are replaced by the features of the ML model. Notably, because most models cannot handle an input with only a partial collection of the features assigned, the v(S) entity is instead replaced with an analogous quantity: v(S)→1/|Z|Σz_{∈Z}v(x_{S}, z_{S̅}) where x_{S}, z_{S̅} represents the input vector where the features in S are set to the values in x and all other values come from z. Quantitative Input Influence (QII), computes feature influence for a sample of data points in the training data set.

QII measures the degree of influence that each input feature exerts on the outputs of the system. There are several variants of QII. Unary QII computes the difference in outputs arising from two related input distributions—the real distribution and a hypothetical (or counterfactual) distribution that is constructed from the real distribution to account for correlations among inputs. Unary QII can be generalized to a form of joint influence of a set of inputs, called Set QII. A third method defines Marginal QII, which measures the difference in output based on comparing training data with and without the specific input whose marginal influence some embodiments want to measure. Depending on the application, some embodiments may choose the training sets the embodiments compare in different ways, leading to several different variants of Marginal QII.

The Shapley value can be assigned to a group of players in two ways, as described below.

$${ϕ}_{G} ( v ) = {\sum }_{( S ) ⊆ N \backslash \{ i \}} \frac{\vert S \vert ! ( \vert N \vert - \vert S \vert - 1 ) !}{\vert N \vert} v ( {⋃}_{i} {S}_{i} ⋃ \{ G \} ) - v ( {⋃}_{i} {S}_{i} ) where N is partition of \{ 1 … n \} \qquad Equation 2$$

In method 1.2.a, the computing machine computes the Shapley values for each feature (as per Equation 1), and then sums the Shapley values for each feature in the group. In method 1.2.b, the computing machine performs a similar analysis to that of method 1.2.a, except during the computation, the computing machine treats the features in the provided feature group as a single entity (as per Equation 2). Specifically, this means that when the features are permuted in the Shapley value computation, the computing machine keeps the features in the group together. To compute this when dealing with a group of features, the computing machine keeps a list of “feature groups” each of which constitute one or more real features. This can be stored in a map structure (e.g., the basic dictionary type of Python (the keys would be strings for a feature group and the values would be a list of strings representing the features in the group)). Then, previously when an operation was to be performed on a feature, some embodiments now perform operations only on feature groups. When there are multiple features in a feature group, the computing machine consults the feature group mapping to retrieve all relevant features and operates on all of the relevant features atomically.

Some embodiments may include one or more of the following: (1) the features are visualized in a way to highlight feature interaction and make group selection easier, (2) automatic selection of feature groups for further analysis using the constructed similarity graph, (3) computing the influence of a group of features, and (4) using any feature influence analysis on a group of features.

Some embodiments are described as numbered examples (Example 1, 2, 3, etc.). These are provided as examples only and do not limit the technology disclosed herein.

Example 1 is a method comprising: accessing, at a computing machine, an artificial intelligence model and a dataset for the artificial intelligence model, the dataset comprising at least one datapoint; identifying a feature group used by the artificial intelligence model, the feature group comprising at least two features having a similarity with one another exceeding a similarity threshold, wherein the feature group comprises a subset of the features used by the artificial intelligence model; determining an overall influence value for the feature group on an output of the artificial intelligence model applied to the dataset; and providing an output representing the overall influence value.

In Example 2, the subject matter of Example 1 includes, wherein the identified features group is manually identified by a user of the computing machine.

In Example 3, the subject matter of Examples 1-2 includes, wherein the identified features group is identified semi-automatically or fully-automatically.

In Example 4, the subject matter of Example 3 includes, wherein the feature group is identified, at the computing machine, using an undirected weighted graph data structure.

In Example 5, the subject matter of Example 4 includes, wherein the graph data structure comprises vertices representing features and edge weights representing similarities between features.

In Example 6, the subject matter of Example 5 includes, wherein the similarities between the features correspond to an absolute value of a correlation between the features.

In Example 7, the subject matter of Examples 5-6 includes, wherein the similarities between the features correspond to a measure of the mutual information between the features or an information gain from a first feature from among the features to a second feature from among the features.

In Example 8, the subject matter of Examples 5-7 includes, wherein the similarities between the features correspond to a symmetrized version of the mutual information.

In Example 9, the subject matter of Example 8 includes, wherein the symmetrized version of the mutual information comprises a symmetric uncertainty.

In Example 10, the subject matter of Examples 5-9 includes, wherein the similarities between the features correspond to a feature similarity metric.

In Example 11, the subject matter of Examples 5-10 includes, wherein the similarity between the features corresponds to a statistical correlation metric.

In Example 12, the subject matter of Examples 5-11 includes, wherein the similarity between the features corresponds to an information theoretic dependence metric.

In Example 13, the subject matter of Examples 1-12 includes, wherein determining the overall influence value for the feature group on the output of the artificial intelligence model applied to the dataset comprises: determining a Shapley value of each and every feature in the feature group; and summing the determined Shapley values to compute the overall influence value.

In Example 14, the subject matter of Examples 1-13 includes, wherein determining the overall influence value for the feature group on the output of the artificial intelligence model applied to the dataset comprises: computing a Shapley value of the feature group as the overall influence value.

Example 15 is at least one machine-readable medium including instructions that, when executed by processing circuitry, cause the processing circuitry to perform operations to implement of any of Examples 1-14.

Example 16 is an apparatus comprising means to implement of any of Examples 1-14.

Example 17 is a system to implement of any of Examples 1-14.

Example 18 is a method to implement of any of Examples 1-14.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, user equipment (UE), article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
accessing, at a computing machine, an artificial intelligence model and a dataset for the artificial intelligence model, the dataset comprising at least one datapoint;
identifying a feature group used by the artificial intelligence model, the feature group comprising at least two features having a similarity with one another exceeding a similarity threshold, wherein the feature group comprises a subset of the features used by the artificial intelligence model;
determining an overall influence value for the feature group on an output of the artificial intelligence model applied to the dataset; and
providing an output representing the overall influence value.

2. The method of claim 1, wherein the identified features group is manually identified by a user of the computing machine.

3. The method of claim 1, wherein the identified features group is identified semi-automatically or fully-automatically.

4. The method of claim 3, wherein the feature group is identified, at the computing machine, using an undirected weighted graph data structure.

5. The method of claim 4, wherein the graph data structure comprises vertices representing features and edge weights representing similarities between features.

6. The method of claim 5, wherein the similarities between the features correspond to an absolute value of a correlation between the features.

7. The method of claim 5, wherein the similarities between the features correspond to a measure of mutual information between the features or an information gain from a first feature from among the features to a second feature from among the features.

8. The method of claim 5, wherein the similarities between the features correspond to a symmetrized version of the mutual information.

9. The method of claim 8, wherein the symmetrized version of the mutual information comprises a symmetric uncertainty.

10. The method of claim 5, wherein the similarities between the features correspond to a feature similarity metric.

11. The method of claim 5, wherein the similarity between the features corresponds to a statistical correlation metric.

12. The method of claim 5, wherein the similarity between the features corresponds to an information theoretic dependence metric.

13. The method of claim 1, wherein determining the overall influence value for the feature group on the output of the artificial intelligence model applied to the dataset comprises:
determining a Shapley value of each and every feature in the feature group; and
summing the determined Shapley values to compute the overall influence value.

14. The method of claim 1, wherein determining the overall influence value for the feature group on the output of the artificial intelligence model applied to the dataset comprises:
computing a Shapley value of the feature group as the overall influence value.

15. A system comprising:
a memory comprising instructions; and
one or more computer processors, wherein the instructions, when executed by the one or more computer processors, cause the system to perform operations comprising:
accessing an artificial intelligence model and a dataset for the artificial intelligence model, the dataset comprising at least one datapoint;
identifying a feature group used by the artificial intelligence model, the feature group comprising at least two features having a similarity with one another exceeding a similarity threshold, wherein the feature group comprises a subset of the features used by the artificial intelligence model;
determining an overall influence value for the feature group on an output of the artificial intelligence model applied to the dataset; and
providing an output representing the overall influence value.

16. The system as recited in claim 15, wherein the identified features group is manually identified by a user.

17. The system as recited in claim 15, wherein the identified features group is identified semi-automatically or fully-automatically.

18. The system as recited in claim 17, wherein the feature group is identified using an undirected weighted graph data structure.

19. The system as recited in claim 18, wherein the graph data structure comprises vertices representing features and edge weights representing similarities between features.

20. A tangible machine-readable storage medium including instructions that, when executed by a machine, cause the machine to perform operations comprising:
accessing an artificial intelligence model and a dataset for the artificial intelligence model, the dataset comprising at least one datapoint;
identifying a feature group used by the artificial intelligence model, the feature group comprising at least two features having a similarity with one another exceeding a similarity threshold, wherein the feature group comprises a subset of the features used by the artificial intelligence model;
determining an overall influence value for the feature group on an output of the artificial intelligence model applied to the dataset; and
providing an output representing the overall influence value.
